(19) United States
(12) Patent Application Publication
(10) Pub. No.: US 2016/0089729 A1
(43) Pub. Date: Mar. 31, 2016

(54) INTERCHANGEABLE BALL MILL

(71) Applicant: NUOVO PIGNONE SRL, Florence (IT)

(72) Inventor: Emanuele CIGNI, Florence (IT)

(21) Appl. No.: 14/893,080

(22) PCT Filed: May 23, 2014
(86) PCT No.: PCT/EP2014/060619

§ 371 Date: Nov. 23, 2015

(30) Foreign Application Priority Data
May 23, 2013 (IT) FI2013A000119

(51) Int. Cl. B23C 5/10; B23C 5/28

(52) U.S. Cl. CPC B23C 5/1009; B23C 5/28; B23C 2210/02; B23C 2240/245; B23C 2240/32; B23C 2250/12

(57) ABSTRACT

A tool is disclosed, including an interchangeable cutting member and an adapter to which said interchangeable cutting member is adapted to be replaceably mounted. The interchangeable cutting member comprises a substantially ball-shaped body with a cutting surface, within which a female screw-thread is provided. The adapter is provided having a male screw-thread portion configured and arranged for screw-engagement in the female screw-thread. A coolant or lubricant fluid passage is provided in the interchangeable cutting member. The coolant or lubricant fluid passage ends at the cutting surface of the ball-shaped member.

### TECHNICAL FIELD

The subject matter disclosed herein relates to cutting tools for metal cutting machines. More specifically, the present subject matter disclosed herein relates to cutting tools comprising an adapter and an interchangeable cutting portion connectable to the adapter for support on a machine tool or a machining center.

### BACKGROUND

Several machining processes require the use of interchangeable ball-shaped cutting tools supported by a holder for connection with a rotating mandrel of machine tools. FIG. 1 illustrates a side view of an interchangeable tool according to the current art and FIG. 2 illustrates the tool of FIG. 1 connected to a mandrel of a machine tool with a tool holder therebetween. The tool 101 comprises a cutting portion 103, which is generally ball-shaped, i.e. having a cutting surface with at least a portion having a substantially spherical shape. The cutting surface of the cutting portion is provided with cutting edges 105 designed for machining of a workpiece by chip-removal, for example for machining an impeller of a turbomachine. The cutting portion 103 is monolithically formed with a spigot 107 having a threaded portion 109 for screw connection to a tool holder 111 shown in FIG. 2. The tool 101 is screw-connected to the tool holder 111 and the latter is mounted on a rotating mandrel 113, for example the mandrel of a working head of a machine tool or machine center.

The tool 101 according to the current art is expensive to manufacture. Moreover, delivery of a coolant or lubrication fluid in the working area of the tool 101 is difficult, especially during machining of complex workpieces, such as impeller vanes.

There is therefore a need for a cutting tool, which at least partly alleviates one or more of the drawbacks of known cutting tools.

### SUMMARY OF THE INVENTION

According to some embodiments, a tool is provided, which comprises an interchangeable cutting member and an adapter to which the interchangeable cutting member is adapted to be replaceably mounted. The interchangeable cutting member comprises a substantially ball-shaped body with a cutting surface, within which a female screw-thread is provided. The adapter can be provided with a male screw-thread portion configured and arranged for screw-engagement in the female screw-thread. Moreover, at least one coolant or lubricant fluid passage can be provided in the interchangeable cutting member. The coolant or lubricant fluid passage ends at the cutting surface of the ball-shaped member. A coolant or lubricant fluid delivery duct is provided in the adapter, in fluid communication with the coolant or lubricant fluid passage when the interchangeable cutting member and the adapter are screwed together. Moreover, in an embodiment, the adapter can be provided with a first conical surface and the interchangeable cutting member is provided with a second conical surface configured and arranged for mutually centering the adapter and the interchangeable cutting member, when the adapter and the interchangeable cutting member are screwed together.

The adapter can further be provided with a first axial abutment surface and the interchangeable cutting member can be provided with a second axial abutment surface. The first axial abutment surface and the second axial abutment surface are mutually engageable for axially positioning the interchangeable cutting member and the adapter one with respect to the other when the interchangeable cutting member and the adapter are screwed together. According to some embodiments, the first axial abutment surface and the second axial abutment surface are orthogonal to a rotation axis of the tool.

According to some embodiments of the subject matter disclosed herein, the first conical surface on the adapter is concave and the male screw-thread portion of the adapter is partly arranged in a cavity formed by the concave first conical surface and projects therefrom. Moreover, the second conical surface on the interchangeable cutting member can be a convex surface formed on a projection of the interchangeable cutting member, the female screw-thread extending in the projection, the projection being configured for engaging in the cavity formed by the concave first conical surface when the interchangeable cutting member and the adapter are screwed together.

According to a further aspect, the subject matter disclosed herein concerns a tool assembly comprising a tool as described above and a tool holder, the adapter of the tool comprising a first connector member co-acting with a second connector member provided on the tool holder.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a side view of a cutting tool of the current art;

FIG. 2 illustrates the use of the cutting tool of FIG. 1 on an electro-mandrel of a machine tool;

FIG. 3 illustrates a side view and a partial section of an adapter of a tool according to the present disclosure in one embodiment;

FIGS. 4 and 5 illustrate side and partial sectional views according to lines IV-IV and V-V of FIG. 6;

FIG. 6 illustrates a front view according to line VI-VI of FIG. 4;

FIG. 7 illustrates a side and partial sectional view of the tool according to FIGS. 3 to 6 in an assembled condition;

FIGS. 8 and 9 illustrate side views oriented at 90° of the tools of FIGS. 3 to 7;

FIG. 10 illustrates a side and partial sectional view of an adapter of a tool according to the disclosure in a second embodiment;

FIG. 11 illustrates the cutting member of the tool according to the second embodiment; and

FIG. 12 illustrates a side and partial sectional view of the tool of FIGS. 10 and 11 with the cutting member attached to the adapter.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

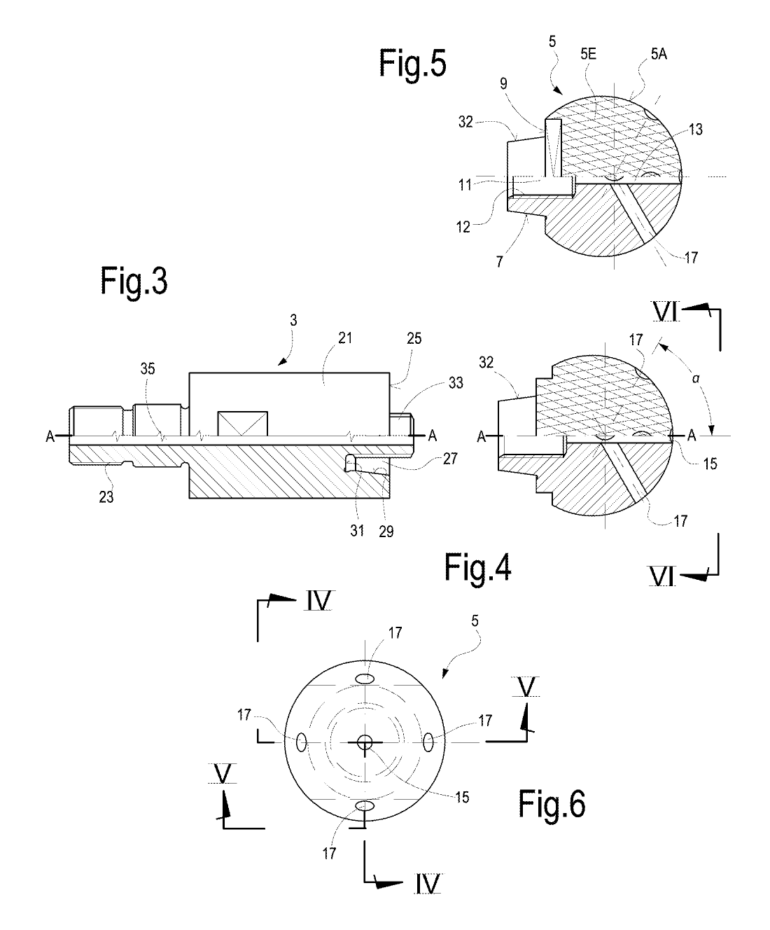

A first embodiment of a tool according to the present disclosure is illustrated in FIGS. 3 to 9. The tool is labeled 1 as a whole. In some embodiments the tool 1 is comprised of an adapter 3 and a cutting member 5. In some embodiments the cutting member 5 and the adapter 3 are connected to one another by means of screw threads as will be described in greater detail here below.

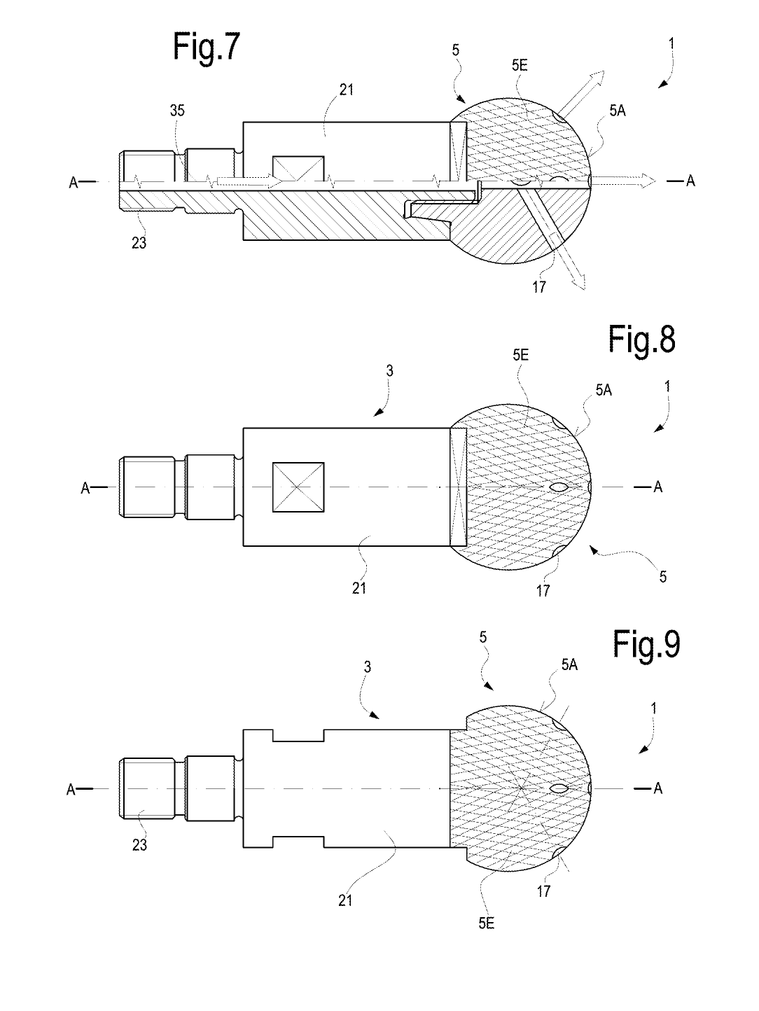

The cutting member 5 comprises an outer surface 5A provided with cutting edges, schematically shown at 5E only in FIG. 7.

The outer cutting surface 5A of the cutting member 5 has a broadly spherical shape in this embodiment.

The cutting member 5 comprises a projection 7 extending from a flat annular surface 9 provided on the cutting member 5. The annular surface 9 is orthogonal to an axis A-A of the cutting member 5.

In some embodiments the projection 7 has a cavity formed by a threaded hole 11, the inner surface whereof is provided with a female screw-thread 12.

In some embodiments a coolant and/or lubricant fluid distribution duct 13 is provided in the interior of the cutting member 5. The coolant and/or lubricant liquid distribution duct 13 is more particularly parallel to and coaxial with axis A-A of the cutting member 5, the axis corresponding to the rotation axis of the tool. In some embodiments the coolant and/or lubricant liquid distribution duct 13 extends from the bottom of the threaded hole 11 and ends with a coolant and/or lubricant fluid passage 15 leading to the outer surface 5A of the cutting member 5.

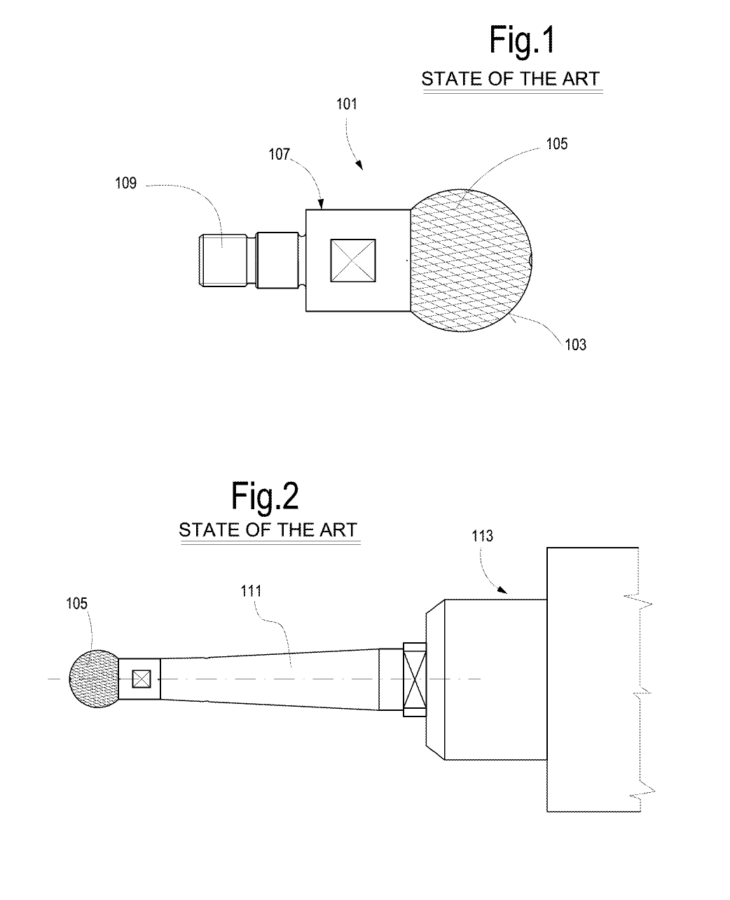

In some embodiments auxiliary or additional coolant and/or lubricant fluid passages are provided in the body of the cutting member 5. In the embodiment illustrated in FIGS. 1 to 9 four such additional coolant and/or lubricant fluid passages 17 are provided. The coolant and/or lubricant fluid passages 17 extend from the central fluid distribution duct 13 towards the surface 5A of the cutting member 5.

In some embodiments the passages 17 are distributed at regular angular intervals around axis A-A and are oriented such as to form an angle a with the axis A-A of the tool which is different from 90°. In particular the inclination of the passages 17 is more particularly such that the passages 17 end at the outer surface 5A of the cutting member 5 in the hemispherical portion of the cutting surface 5A opposite projection 7.

In some embodiments, the adapter 3 comprises a central body 21 from which a threaded spigot 23 extends. The threaded spigot 23 is configured for connection with a holder, for example a holder 111 as shown in FIG. 2.

In an embodiment, on the end of the central body 21 to the spigot 23, the adapter 3 is provided with a planar front surface 25. The front surface 25 can be annular and surrounding an inner cavity 27 extending inside the central body 21.

In some embodiments the inner cavity 27 has an inner side surface 29 having a conical frustum-shaped form and ends with a bottom 31. The inclination of the conical frustum-shaped surface 29 is substantially the same as the inclination of an external conical frustum-shaped surface 32 provided on the outside of the projection 7.

From the bottom 31 of the inner cavity 27 of the adapter 3 a male screw-thread portion 33 extends coaxial with the conical frustum-shaped surface 29 and projects beyond the planar annular surface 25.

As can be better appreciated from FIG. 7, when the cutting member 5 is connected with the adapter 3, the male screw-thread portion 33 of the adapter 3 is screw-engaged with the female screw-thread 12 provided on the inner surface of cavity 11 formed in the cutting member 5 so as to provide connection between the adapter 3 and the cutting member 5.

The cutting member 5 and the adapter 3 are screwed together until the annular planar surface 25 abuts against the annular planar surface 9 provided on the cutting member 5, the surfaces 25 and 9 providing first and second abutting surfaces respectively, which define the mutual axial position of the cutting member 5 with respect to the adapter 3 when the two components of the tool 1 are connected to one another.

The concave conical frustum-shaped surface 29 co-acts with the convex conical frustum-shaped surface 32 to provide a centering and a supporting action during screw-connection of the adapter 3 to the cutting member 5.

The depth of the inner cavity 27 and the extension of the projection 7, as well as the length of the male screw-thread portion 33 and the depth of the cavity 11 are chosen so that in the assembled condition (FIG. 7) the cutting member 25 and the adapter 3 are in mutual contact only along the two conical frustum-shaped surfaces 29 and 32 and at the mutually meshing screw-threads provided on the male screw-thread portion 33 and in the cavity 11.

In some embodiments the adapter 3 is provided with a coolant and/or lubricant delivered duct 35. In some embodiments the coolant and/or lubricant fluid delivery duct 35 is coaxial with the adapter 3, i.e. the axis of the duct 35 coincides with the axis A-A of the adapter 3 and correspondingly with the axis A-A of the cutting member 5 and of the assembled tool 1 (see FIGS. 7, 8 and 9).

The coolant and/or lubricant delivery duct 35 extends from one end of the adapter 3 to the opposite end thereof. More specifically, the coolant and/or lubricant fluid delivery duct 35 extend from the terminal end surface of the spigot 23 to the front surface of the male screw-thread portion 33.

When the cutting member 5 and the adapter 3 are screw connected to one another (FIG. 7) a distribution system for delivering the coolant or lubricant fluid is established, which extends from the spigot 23 to the cutting surface 5A of the cutting member 5. A coolant and/or lubricant fluid can thus be dispensed through the holder 111 (which can similarly be provided with a through passage), across the adapter 3 and the cutting member 5 and finally delivered exactly there where it is needed, namely in the area of contact between the cutting surface 5A and a work-piece being machine with the tool 1. Delivery of the coolant and/or lubricant fluid is thus made easier in all those situations where delivery of the coolant and/or lubricant fluid through an external nozzle would be difficult or critical, for example inside a vane of an impeller.

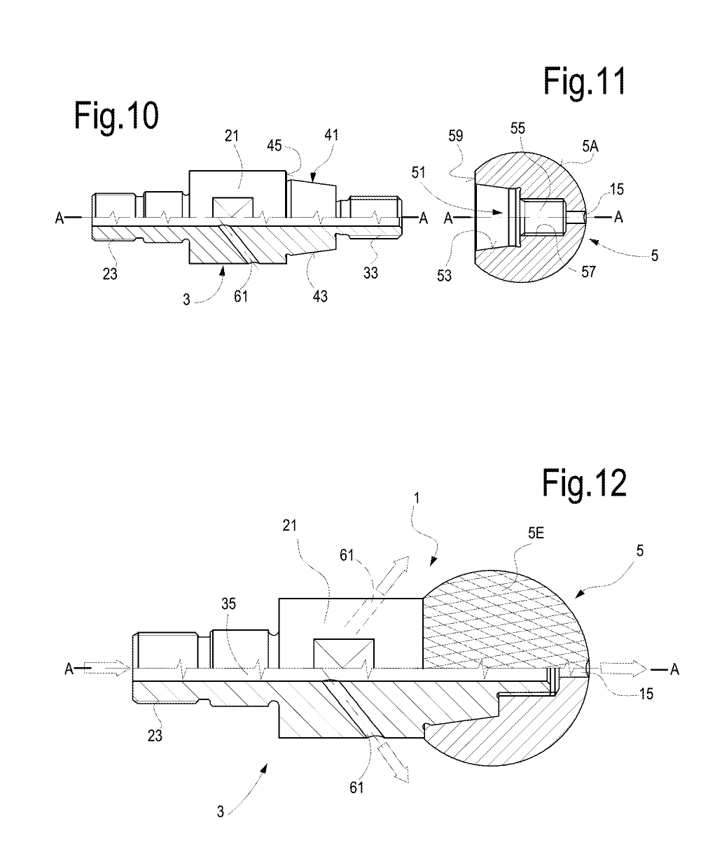

A second embodiment of the tool according to the present disclosure is shown in FIGS. 10 to 12. The same reference numbers are used to designate similar, identical or equivalent portions, components, or elements as shown in FIGS. 3 to 9.

In the embodiment of FIGS. 10 to 12 the adapter 3 is again provided with a threaded spigot 23 and a coolant and/or lubricant fluid delivery duct 35 extending through the entire axial length of the adapter 3.

On the side of the central body 21 opposite the spigot 23, the adapter 3 is provided with an intermediate portion 41 forming an outer conical frustum-shaped surface 43. In an embodiment, the larger base of the frustum-shaped surface 43 is surrounded by a planar annular surface 45, which is coaxial therewith and with the spigot 23 and the body 21 of the adapter 3. From the smaller base of the conical frustum-shaped portion 41 a male screw thread portion labeled 33 projects from the adapter 3.

The cutting member 5 comprises an inner cavity 51, extending co-axially with the cutting member 5. The cavity 51 has a first portion or section having a conical frustum-shaped inner side surface 53. The conical frustum-shaped surface 53 has substantially the same shape as the conical frustum-shaped convex surface 43 to form a pair of supporting and guiding surfaces.

The cavity 51 extends further within the body of the cutting member 5 to form a threaded hole 55, wherein a female screw-thread 57 is provided. A coolant and/or lubricant fluid passage 15 extends from the bottom of the hole 55 towards the surface of the cutting member 5.

FIG. 12 illustrates the tool 1 of the second embodiment with the cutting member 5 screwed on the adapter 3. The two conical frustum-shaped surfaces 32 and 53 co-act with one another providing a guiding and centering action between the two components 3 and 5 of the tool 1. The male screw-thread portion 33 is screw-engaged in the threaded hole 55, the male screw-thread engaging the female screw-thread 57. The annular planar surface 45 forms an abutment co-acting with a planer annular surface 59 provided on the cutting member 5 and surrounding cavity 51.

The depth of the cavity 51, of the hole 55, as well as the axial length of the conical portion 41 and of the male screw-thread portion 33 of the adapter 3 are chosen so that in the assembled condition (FIG. 12) the two components 3 and 5 abut one against the other only at surfaces 45 and 59.

Coolant and/or lubricant fluid is delivered through the duct 35 from a holder 111 to the passage 15.

In some embodiments additional coolant and/or lubricant fluid passages 61 can be provided. In some embodiments, such additional passages 6l can be provided in the adapter 3, for example in the body 21 thereof. The inclination of these additional passages 61 is such that a jet of coolant and/or lubricant fluid is directed towards and around the cutting member 5 for cooling and lubricating purposes as well as for removing of chips from the machining area.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A tool comprising:
an interchangeable cutting member and an adapter to which said interchangeable cutting member is adapted to be replaceably mounted; wherein:
the interchangeable cutting member comprises a substantially ball-shaped body with a cutting surface, wherein the body comprises a female screw-thread formed therein;
the adapter comprises a male screw-thread portion configured and arranged for screw-engagement in the female screw-thread;
the interchangeable cutting member comprises at least one coolant or lubricant fluid passage, said coolant or lubricant fluid passage ending at the cutting surface of the ball-shaped member;
the adapter comprises a coolant or lubricant fluid delivery duct, said coolant or lubricant fluid delivery duct being in fluid communication with said coolant or lubricant fluid passage when the interchangeable cutting member and the adapter are screwed together;
the adapter comprises a first conical surface and the interchangeable cutting member comprises a second conical surface configured and arranged for mutually centering said adapter and said interchangeable cutting member, when the adapter and the interchangeable cutting member are screwed together.

2. The tool of claim 1, wherein said adapter comprises a first axial abutment surface and said interchangeable cutting member comprises a second axial abutment surface, said first axial abutment surface and said second axial abutment surface being mutually engageable for axially positioning the interchangeable cutting member and the adapter one with respect to the other when said interchangeable cutting member and said adapter are screwed together.

3. The tool of claim 2, wherein said first axial abutment surface and said second axial abutment surface are orthogonal to a rotation axis of the tool.

4. The tool of claim 1, wherein the first conical surface on the adapter is concave and the male screw-thread portion of the adapter is partly arranged in a cavity formed by said concave first conical surface and projects therefrom; and wherein the second conical surface on the interchangeable cutting member is a convex surface formed on a projection of said interchangeable cutting member, the female screw-thread extending in said projection, said projection being configured for engaging in the cavity formed by the concave first conical surface when the interchangeable cutting member and the adapter are screwed together.

5. The tool of claim 2, wherein the second axial abutment surface extends around a larger base of the second conical surface on the interchangeable cutting member and the first axial abutment is arranged at the inlet of said cavity and surrounds the male screw-thread portion.

6. The tool of claim 1, wherein the at least one coolant or lubrication fluid passage is coaxial with the female screw-thread of the interchangeable cutting member.

7. The tool of claim 1, wherein the at least one coolant or lubricant fluid passage is coaxial with a rotation axis of the tool.

8. The tool of claim 7, wherein the interchangeable cutting member comprises a plurality of additional coolant or lubricant fluid passages, extending from a central fluid distribution duct towards the cutting surface of the ball-shaped member and are arranged around the rotation axis of the cutting tool.

9. The tool of claim 1, wherein: the first conical surface is a convex conical surface formed on a terminal portion of the adapter; the second conical surface is a concave conical surface; the male screw-thread portion projects from the terminal portion of the adapter; and the female screw-thread extends from a bottom of the concave conical surface formed in the interchangeable cutting member.

10. A tool assembly comprising a tool according to claim 1 and a tool holder, the adapter of the tool comprising a first connector member co-acting with a second connector member provided on said tool holder.

11. The tool assembly of claim 10, wherein said first connector member and said second connector member comprise screw threads.

12. The tool of claim 2, wherein the first conical surface on the adapter is concave and the male screw-thread portion of the adapter is partly arranged in a cavity formed by said concave first conical surface and projects therefrom; and wherein the second conical surface on the interchangeable cutting member is a convex surface formed on a projection of said interchangeable cutting member, the female screw-thread extending in said projection, said projection being configured for engaging in the cavity formed by the concave first conical surface when the interchangeable cutting member and the adapter are screwed together.

13. The tool of claim 3, wherein the first conical surface on the adapter is concave and the male screw-thread portion of the adapter is partly arranged in a cavity formed by said concave first conical surface and projects therefrom; and wherein the second conical surface on the interchangeable cutting member is a convex surface formed on a projection of said interchangeable cutting member, the female screw-thread extending in said projection, said projection being configured for engaging in the cavity formed by the concave first conical surface when the interchangeable cutting member and the adapter are screwed together.

14. The tool of claim 4, wherein the second axial abutment surface extends around a larger base of the second conical surface on the interchangeable cutting member and the first axial abutment is arranged at the inlet of said cavity and surrounds the male screw-thread portion.
